(19) United States
(12) Patent Application Publication
(10) Pub. No.: US 2012/0275951 A1
(43) Pub. Date: Nov. 1, 2012

(54) System for Decreasing Environmental Corrosion Factors and/or for Delivering One or More Corrosion Inhibiting Compounds to an Enclosure

(75) Inventors: Efim Ya Lyublinski, Solon, OH (US); Yefim Vaks, South Euclid, OH (US)

(73) Assignee: NORTHERN TECHNOLOGIES INTERNATIONAL CORPORATION, Beachwood, OH (US)

(21) Appl. No.: 13/495,416

(22) Filed: Jun. 13, 2012

Related U.S. Application Data
(63) Continuation-in-part of application No. 11/602,129, filed on Nov. 20, 2006, now abandoned.

(51) Int. Cl. C23F 11/02; B01J 7/00

(52) U.S. Cl. 422/10; 422/292

(57) ABSTRACT

The present invention generally relates to portable systems designed to deliver one or more corrosion inhibiting compounds to an enclosure, and to method for using same. More specifically, the present invention relates to portable, mobile, self-contained and/or discrete systems designed to deliver one or more corrosion inhibiting compounds to an enclosure while simultaneously purging and/or recycling the interior atmosphere of such an enclosure, and to methods for using same. In another embodiment, the present invention relates to portable systems designed to deliver one or more corrosion inhibiting compounds to an enclosure while simultaneously dehumidifying, purging and/or recycling the interior atmosphere of such an enclosure, and to methods for using same. Another aspect of the present invention is that the recycled atmosphere of the enclosure can be passed through an absorbent that removes and/or collects the volatilized metal corrosion inhibitor compound. The collected corrosion inhibitor can later be reused.

### CROSS REFERENCE

This application is a Continuation-in Part application of application Ser. No. 11/602,129, filed Nov. 20, 2006, which is hereby incorporated herein by reference in its entirety.

### FIELD OF THE INVENTION

The present invention generally relates to portable systems designed to deliver one or more corrosion inhibiting (i.e., one or more corrosion inhibiting and/or tarnish inhibiting compounds) to an enclosure, and to method for using same. More specifically, the present invention relates to portable, mobile, self-contained and/or discrete systems designed to deliver one or more corrosion inhibiting compounds to an enclosure while simultaneously purging and/or recycling the interior atmosphere of such an enclosure, and to methods for using same. In another embodiment, the present invention relates to portable systems designed to deliver one or more corrosion inhibiting compounds to an enclosure while simultaneously dehumidifying, purging and/or recycling the interior atmosphere of such an enclosure, and to methods for using same. In still another embodiment, the present invention relates to heat-based portable systems designed to deliver one or more corrosion inhibiting compounds to an enclosure while simultaneously dehumidifying, purging and/or recycling the interior atmosphere of such an enclosure. The invention also relates to absorbing the recycled corrosion inhibitor to remove the same from the system as upon completion of a metal protection cycle.

### BACKGROUND OF THE INVENTION

In commerce and industry today, the useful life of a variety of items may be extended and/or preserved by providing one or more suitable inhibitors. An inhibitor is a compound or group of compounds which can slow or negate the rate of decomposition, degradation and/or spoilage of a given item due to, for example, corrosion or oxidation. For example, certain metals are prone to corrosion and/or tarnishing. A suitable inhibitor, in such a case, would be a compound (or group of compounds) which acts as a corrosion and/or tarnish inhibitor thereby protecting a desired item or items from the adverse effects of its ambient environment.

Among the common indications of corrosion manifested in useful metallic articles are oxidation, pitting, tarnishing, mottling or discoloration of the surfaces of these items. These manifestations occur in metallic articles, particularly when exposed to oxygen, in either gaseous or liquid phase. Additionally, sulfides and/or chlorides (or chlorine) may cause corrosion or tarnishing problems as well. Inasmuch as both oxygen and water, including water vapor, occur normally and are available in nature, it is normally necessary to take precautions against corrosion when packaging metallic items for shipment or storage, or when subjecting such items to normal use. Metals which are frequently found to be susceptible to corrosion under normal atmospheric and ambient conditions include, but are not limited to, iron, copper, brass, aluminum, silver, and alloys, of these metals. Additionally, suitable protection may also be needed for valuable non-metal items, such as precious and/or semi-precious stones and the like, or hybrid articles (i.e., articles that are partially metal or contain a significant amount of metal therein) such as reinforced concrete.

In view of the widespread need for protecting various articles from corrosion, be the articles metallic or otherwise, a variety of short-lived systems have been utilized. For example, the use of VCI capsules permits a producer/manufacturer to place a VCI capsule in an existing packaging system or enclosure, without having to redesign same, while still making sure that the products contained within the packaging are protected against corrosion, tarnishing or some other form of degradation.

Such methods, although effective, are not suitable for all situations. In some situations, the need for the inhibition of a form of degradation is initially high and then lessens or declines over time. Current systems offer basic linear performance over a given amount of time and fail to provide adequate protection initially (and then later provide surplus protection when unneeded). Thus, current systems are engineered to release a constant amount of inhibitor over a given life time. Such systems include foam-based VCI or anti-tarnish capsules. Additionally, current systems offer inadequate protection of large enclosures (e.g., storage tanks, heat exchangers, compressors, buildings, electronic compartments, storage structures, etc.) as the use of VCI capsule-based protection systems is impractical in that an unmanageable number of VCI capsules are typically needed to protect large enclosures.

Thus, there is a need for a system and method which provides flexible corrosion and/or tarnish protection in light of, or in response to, a changing environment, while at the same time permitting the flexible delivery of differing amounts of one or more volatilizable compounds. There is also an economic need to remove the VCI compounds upon completion of a protection cycle and also to prevent the compounds from contaminating the environment.

### SUMMARY OF THE INVENTION

The present invention generally relates to portable systems designed to deliver one or more corrosion inhibiting (i.e., one or more corrosion inhibiting and/or tarnish inhibiting compounds) to an enclosure, and to method for, using same. More specifically, the present invention relates to portable, mobile, self-contained and/or discrete systems designed to deliver one or more corrosion inhibiting compounds to an enclosure while simultaneously purging and/or recycling the interior atmosphere of such an enclosure, and to methods for using same. In another embodiment, the present invention relates to portable systems designed to deliver one or more corrosion inhibiting compounds to an enclosure while simultaneously dehumidifying, purging and/or recycling the interior atmosphere of such an enclosure, and to methods for using same. In still another embodiment, the present invention relates to heat-based portable systems designed to deliver one or more corrosion inhibiting compounds to an enclosure while simultaneously dehumidifying, purging and/or recycling the interior atmosphere of such an enclosure, and to methods for using same. Another aspect to the present invention relates to removing or eliminating the remaining or unused volatile corrosion inhibitors through the use of specific absorbents so that the same is not released to the environment. Still other aspects of the present invention relate to use of various types of filters such as to remove unwanted particles (H₂S, SO₂, for example), dust, and the like from the atmosphere of the enclosure.

In one embodiment, a process for protecting metals in an enclosure, comprises the steps of volatilizing at least one metal corrosion inhibitor compound; delivering said volatilized metal corrosion inhibitor compound to said enclosure; recycling the interior atmosphere of said enclosure containing said volatilized metal corrosion inhibitor; and sorbing said volatile corrosion metal inhibitor from said recycled atmosphere.

In another embodiment, the present invention relates to a system for delivering at least one volatilizable inhibiting compound to at least one enclosure, comprising at least one volatilizable corrosion inhibiting component comprising a volatile, metal corrosion inhibitor; a heat source for volatilizing said metal corrosion inhibitor compound; a mechanical device for delivering the at least one volatilizable, metal corrosion-inhibiting compound to the at least one enclosure; optionally a dehumidifying device for reducing the amount of relative humidity in the at least one enclosure; a directional air flow device for directing the vapor phase of the at least one volatilizable, metal corrosion-inhibiting compound within the at least one enclosure and for recycling the atmosphere of the interior of the enclosure; wherein the combination of the vapor phase of the at least one volatilizable, metal corrosion-inhibiting compound, and the directional air flow device, cause a reduction in the amount of said one or more metal corrosion causing compounds within the interior environment of the one or more enclosures; and an absorbent for absorbing said volatilized metal corrosion inhibitor compound from the recycled atmosphere.

In still another embodiment, the present invention relates to a system for delivering at least one volatilizable inhibiting compound to at least one enclosure, comprising an inhibitor unit comprising at least one volatilizable, metal corrosion-inhibiting compound comprising a volatile, metal corrosion inhibitor; a mechanical device, for delivering an increased partial pressure and/or vapor pressure of the at least one volatilizable, metal corrosion-inhibiting compound to the at least one enclosure; at least one heat source; an automatic control device adapted to control the release of the at least one volatilizable corrosion-inhibiting compound; a directional air flow device for directing the vapor phase of the at least one volatilizable, metal corrosion-inhibiting compound within the at least one enclosure; and wherein the combination of the vapor phase of the at least one volatilizable, metal inhibiting compound and the directional air flow device cause a reduction in the amount of said one or more metal corrosion causing compounds within the interior environment of the one or more enclosures.

### BRIEF DESCRIPTION OF THE DRAWINGS

FIG. 1 illustrates a portable system 100 in accordance with one embodiment of the present invention;

FIG. 2 illustrates an enclosure-based system 200 in accordance with one embodiment of the present invention;

FIG. 3 illustrates an enclosure-based system 300 in accordance with another embodiment of the present invention, where the system is utilized in conjunction with a collapsible enclosure inside a storage facility or building;

FIG. 4 illustrates the enclosure-based system 300 of FIG. 3, where the collapsible enclosure has been lifted up;

FIG. 5 illustrates an enclosure-based system 500 in accordance with yet another embodiment of the present invention, where the system is utilized in conjunction with a collapsible enclosure;

FIG. 6 is a picture of a model of the enclosure-based system 500 of FIG. 5;

FIG. 7 is a humidity plot graph illustrating an exemplary drop in relative humidity provided by a system in accordance with one embodiment of the present invention;

FIG. 8 is a humidity plot graph illustrating an exemplary drop in relative humidity provided by a system in accordance with one another embodiment of the present invention;

FIG. 9 is a humidity plot graph illustrating an exemplary drop in relative humidity provided by a system in accordance with one still another embodiment of the present invention;

FIG. 10 is a schematic flow diagram of another embodiment of the present invention illustrating application of the volatilized metal corrosion inhibiting compounds to the atmosphere of an enclosure wherein various aspects of the inventive system can occur simultaneously or in steps; and

FIG. 11 is a schematic of another embodiment of the present invention illustrating application of the volatilized metal corrosion inhibiting compounds to the atmosphere of an enclosure wherein various aspects or treatments of the inventive system can occur simultaneously or in steps.

### DETAILED DESCRIPTION OF THE INVENTION

The present invention generally relates to portable systems designed to deliver one or more corrosion inhibiting (i.e., one or more corrosion inhibiting and/or tarnish inhibiting compounds) to an enclosure, and to method for using same. More specifically, the present invention relates to portable, mobile, self-contained and/or discrete systems designed to deliver one or more corrosion inhibiting compounds to an enclosure while simultaneously purging and/or recycling the interior atmosphere of such an enclosure, and to methods for using same. In another embodiment, the present invention relates to portable systems designed to deliver one or more corrosion inhibiting compounds to an enclosure while simultaneously dehumidifying, purging and/or recycling the interior atmosphere of such an enclosure, and to methods for using same. In still another embodiment, the present invention relates to heat-based portable systems designed to deliver one or more corrosion inhibiting compounds to an enclosure while simultaneously dehumidifying, purging and/or recycling the interior atmosphere of such an enclosure, and to methods for using same. Another advantage of the present invention is that any remaining or unused VCI are absorbed to protect the environment upon completion of the metal protection treatment.

In yet another embodiment, the present invention relates to a portable, mobile, self-contained and/or discrete systems designed to provide, at a minimum, dehumidification to one or more enclosures.

Additionally, as used throughout the text and claims, corrosion includes not only tarnishing, rusting and other forms of corrosion, but also includes any detrimental or unwanted degradation of an article to be protected. As such, when the phrases “corrosion inhibiting compound(s)” or “corrosion inhibitor(s)” are used herein, these phrases also include tarnish inhibiting compound(s) or tarnish inhibitor(s). In one embodiment, the corrosion inhibiting compound or compounds utilized in conjunction with the present invention are volatile inhibitors. A volatile inhibitor is a compound, or a mixture of compounds, with a finite vapor pressure which, under a given set of conditions, can generate vapors which may or may not condense on any surface with which the vapors come into contact. Generally, the lower a compound's or a mixture's vapor pressure the more difficult it is to generate vapors from such a compound or mixture.

As is noted above, in some embodiments the present invention relates to heat-based portable systems designed to deliver one or more corrosion inhibiting compounds to an enclosure while simultaneously dehumidifying, purging and/or recycling the interior atmosphere of such an enclosure. In such embodiments, the systems of the present invention can be utilized in any situation where a volatilizable compound is desired and the use of heat is not a deterrent. Such situations can include, but are not limited to, electronic compartments, electrical sub-stations, metallic enclosures, storage tanks, septic tanks, containers (e.g., shipping containers, storage containers, reservoirs, etc.); and/or closed systems (e.g., waste disposal systems, waste disposal drums or containers, etc.). Furthermore, in those embodiments of the present invention were at least one heat source is present, such a heat source also provides a dehumidification function to the systems of the present invention. This dehumidification function can entail, among other things, increasing the service life of any desiccant present in the systems according to the present invention.

In one embodiment, the present invention relates to a system that is designed to deliver one or more corrosion inhibiting compounds to one or more fully sealed enclosures, and to methods of using same. By fully sealed enclosure it is meant that such an enclosure does not permit the infusion, intrusion and/or inclusion of any environment external to the interior of the fully sealed enclosure. In these embodiments, the present invention permits, simultaneously, a change in the environment of the enclosure and delivery of one or more corrosion inhibiting compounds to an interior environment.

In another embodiment, the present invention can be used to provide one or more corrosion inhibiting compounds to one or more partially sealed enclosures. By partially sealed enclosure it is meant that the enclosure is not totally and/or completely sealed from any one or more environments external to the interior of the partially sealed enclosed. Given this, such partially sealed enclosures permit and/or allow the infusion, intrusion and/or inclusion of an external environment into the interior of the partially sealed enclosure. In certain instances, in the case of partially sealed enclosures, the present invention, can be designed to provide an over pressure to the enclosure (i.e., a pressure greater than the surrounding pressure of the external atmosphere) thereby preventing and/or reducing the amount of an external atmosphere that enters a given enclosure.

In one embodiment, the systems according to the present invention permit an increase in the amount of volatilizable compound or compounds present in one or more enclosures by at least a factor of about 3 over the amount generated in a given period of time (e.g., one hour) at room temperature and pressure (approximately 25° C. and 1 atmosphere) by prior art methods (e.g., the use of stationary VCI capsules that are inserted into an enclosure). In another embodiment, the systems of the present invention permit an increase in the amount of volatilizable compound or compounds present in one or more enclosures by at least a factor of about 5, by a factor of at least about 10, or by a factor of at least about 100, over the amount generated in a given period of time (e.g., one hour) at room temperature and pressure (approximately 25° C.′ and 1 atmosphere) by prior art methods (e.g., the use of stationary VCI capsules that are inserted into an enclosure).

In another embodiment, the present invention utilizes a heating means, as will be discussed in detail below, to generate a temperature in the range of about 40° C. to about 90° C., or about 45° C. to about 85° C., or even from about 50° C. to about 80° C. It should be noted that here, as well as elsewhere in the specification and claims, individual range and ratio limits may be combined.

The heat source acts to increase the amount of volatilizable compound or compounds which are initially generated by the systems of the present invention by increasing the vapor pressure of the volatilizable compound(s) contained therein. In one embodiment, the heat source of the present invention increases the amount of vapor generated by the one or more volatilizable compounds by at least a factor of about 3 over the amount generated in a given period of time (e.g., one hour) at room temperature and pressure (approximately 25° C. and 1 atmosphere). In another embodiment, the heat source of the present invention increases the amount of vapor generated by the one or more volatilizable compounds by a factor of at least about 5, by a factor of at least about 10, or by a factor of at least about 100, over the amount generated in a given period of time (e.g., one hour) at room temperature and pressure (approximately 25° C. and 1 atmosphere).

In one embodiment, the optional heat source in a heat-based system of the present invention is active (i.e., maintains a minimum temperature within one of the above stated ranges) and generates an increased amount of vapor (as discussed above) for any suitable period of time. In one embodiment, this period is at least about 1 hour, or at least about 12 hours, or even at least about 1 year. In another embodiment, the heat source is active for a period of about 1 hour to about 240 hours, or about 4 hours to about 168 hours, or even about 6 hours to about 120 hours. In another embodiment, the heat source is active for a period of about 2 hours to about 1 year.

Generally, a system in accordance with the present invention contains, at a minimum, the following components: (1) at least one source of one or more corrosion inhibiting compounds; and (2) a means for portably delivering the one or more corrosion inhibiting compounds to an enclosure. Another important aspect of the present invention is the utilization of absorbents to remove any remaining corrosion inhibiting compounds as upon completion of a metal protection cycle. Optionally, a system in accordance with the present invention can optionally contain, in addition to the elements listed above, at least one dehumidifying means and at least one heat source. In one embodiment, the means for portably delivering the one or more corrosion inhibiting compounds to an enclosure includes a means for purging and/or recycling the interior atmosphere of such an enclosure.

### I. Volatilizable Compounds

As is noted above, the systems, according to the present invention, include therein at least one volatilizable compound and/or formula. In another embodiment, the present invention includes therein at least one volatilizable inhibiting compound and/or formula. Any compound which can be volatilized can be used in the present invention, whether solid or liquid. In another embodiment, the one or more volatilizable compounds or formulas of the present invention can be contained in any suitable polymer or polymer film, foam, powder, tablet (e.g., the polymer can be a polyolefin or any suitable biodegradable polymer, such as a biodegradable polyester or copolyester polymer). Suitable types of volatilizable compounds and/or formulas include volatile corrosion inhibitors, volatile tarnish inhibitors, anti-oxidants, anti-mildew, anti-bacterials and/or UV-protectants.

In one embodiment, any compound which is to be utilized in the present invention should generate a sufficient partial pressure at a temperature in the range of about 40° C. to about 90° C., or about 45° C. to about 85° C., or even from about 50° C. to about 80° C. In another embodiment, the partial pressure of the one or more volatilizable compounds should be at least about 3 to 100 times higher than the partial pressure of the one or more volatilizable compounds at 25° C.

In still another embodiment, the partial pressure of the one or more volatilizable compounds should be at least about 100 Pascals (Pa) instead of about 1 Pa, at least about 5 Pa instead of about 0.1 Pa, or even at least about 1⁻² Pa instead of about 10⁻ Pa, at any temperature within the above stated temperature ranges. A chart detailing vapor pressure for various inorganic and organic compounds and their partial pressures, or even greater than atmospheric pressures, at certain temperatures can be found in the CRC Handbook of Chemistry and Physics, 67th Edition, pages D-192 through D-212, which is hereby incorporated by reference for its disclosure relating to vapor pressure. Additional vapor pressure related material may also be found in the CRC Handbook of Chemistry and Physics, 77th Edition, pages 6-67 through 6-113, which is hereby incorporated by reference for its disclosure relating to vapor pressure.

In one embodiment, the present invention contains therein one or more volatilizable corrosion and/or tarnish inhibiting compounds or formulas.

A. Corrosion Inhibiting and Tarnish Inhibiting Compounds or Formulas:

The following formulas are exemplary corrosion inhibiting and/or tarnish inhibiting compounds or formulas and the present invention is not limited solely to the following compounds and/or formulas.

Any suitable corrosion inhibitor can be used in the present invention. U.S. Pat. Nos. 4,290,912; 5,320,778; and 5,855,975 disclose vapor phase or volatile corrosion inhibitors and are incorporated herein by reference in their entirety for their teachings of such compounds. For example, useful vapor phase or volatile corrosion inhibitors include, but are not limited to, benzotriazole, and mixtures of benzoates of amine salts with benzotriazole, nitrates of amine salts and C₁₃H₂₆O₂N, certain amines and imines, imidazolines and/or imidazoles, triazoloes, pyridines, amides, phosphonates, and sulphonates and their derivatives. Other suitable corrosion inhibitors are described in Corrosion Inhibitors: Principle and Applications, V. S. Sastri, Wiley, New York, N.Y., 1998.

Alternatively, the present invention can utilize a biodegradable polymer-corrosion inhibitor combination as is disclosed in United States Published Patent Application No. 2004/0173779, which is incorporated herein in its entirety for its teaching of biodegradable polymer-corrosion inhibitor combinations. In still another embodiment, the present invention can utilize polymer miscible corrosion inhibiting compositions such as those disclosed in United States Published Patent Application No. 2004/0069972, which is incorporated herein in its entirety for its teaching of corrosion inhibiting compositions. In yet another embodiment, the present invention can utilize any of the corrosion inhibiting formulas and/or compounds disclosed in United States Published Patent Application No. 2003/0213936, which is incorporated herein in its entirety for its teaching of corrosion inhibiting compositions. In still yet another embodiment, the present invention can utilize a tarnish inhibiting compound or formula as disclosed in United States Published Patent Application Nos. 2004/00063837 and 2003/0207974, which are both incorporated in their entireties for their teachings of tarnish inhibiting compounds and/or formulas.

1. Exemplary Corrosion Inhibiting Formulas:

In one embodiment, a suitable corrosion inhibiting formula for inclusion into the present invention comprises a mixture of: (1a) at least one volatile corrosion inhibitor (VCI); (1b) at least one anti-oxidant; (1c) at least one alkali or alkaline-earth metal silicate or oxide; and (1d) fumed silica.

In another embodiment, the corrosion inhibiting formula comprises a mixture of: (2a) at least one volatile corrosion inhibitor (VCI); (2b) at least one anti-oxidant; (2c) at least one alkali or alkaline-earth metal silicate or oxide; (2d) fumed silica; and (2e) at least one chemically active compound.

In yet another embodiment, the corrosion inhibiting formula comprises a mixture of: (3a) an inorganic nitrite salt; (3b) a phenol represented by the formula:

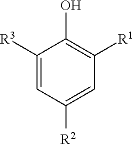

where R¹, R² and R³ are selected from alkyl, aryl, alkenyl, hydroxyalkyl, hydroxyalkenyl and where the sum of carbon atoms in R¹, R² and R³ is in the range of 3 to about 18; and (3c) fumed silica. All of the mixtures described above can further include additional additives.

### a. Volatile Corrosion Inhibitors

Any suitable volatile corrosion inhibitor (or vapor phase corrosion inhibitor) can be utilized in the at least one corrosion inhibiting formula contained in the present invention. As is noted above, some suitable volatile corrosion inhibitors are disclosed in U.S. Pat. Nos. 4,290,912; 5,320,778; and 5,855,975, which are all incorporated herein by reference in their entirety for their teachings of such inhibitors. For example, useful vapor phase or volatile corrosion inhibitors include, but are not limited to, triazoles and/or inorganic nitrites (e.g., nitrite salts).

In one embodiment, exemplary inorganic nitrite salts include, but are not limited to, metal nitrites, such as sodium nitrite, potassium nitrite and barium nitrite. In another embodiment, any suitable Group 1 or Group 2 nitrite (New Notation System) can be used in the at least one corrosion inhibiting formula contained in the present invention.

In another embodiment, the one or more vapor phases or volatile corrosion inhibitors utilized in the present invention can be a triazole. Exemplary triazoles include, but are not limited to, benzotriazole, tolyltriazole and/or sodium tolyltriazole.

In yet another embodiment, the vapor phase or volatile corrosion inhibitor utilized in the present invention can be any suitable mixture of two or more of the above-mentioned inhibitors.

### b. Anti-Oxidants

Any suitable anti-oxidant can be utilized in the at least one corrosion inhibiting formula contained in the present invention. Exemplary anti-oxidants include, but are not limited to, tri-substituted phenols independently substituted in the 2, 4 and 6 positions with one or more alkyl, hydroxyalkyl, aryl, alkenyl or hydroxyalkenyl groups of the general formula shown below.

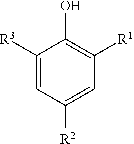

In one embodiment, the sum of the carbon atoms present in the substituent groups R¹, R² and R³ is in the range of 3 to about 36, or even in the range of 3 to about 18.

In another embodiment, a mixture of two or more of the above-mentioned anti-oxidants can be utilized in the at least one corrosion inhibiting formula contained in the present invention.

### c. Alkali/Alkaline-Earth Metal Silicates/Oxides

Any suitable Group 1 or 2 silicate or oxide can be utilized in the at least one corrosion inhibiting formula contained in the present invention. Exemplary silicates include lithium silicate, sodium silicate, potassium silicate and barium silicate. With regard to the silicates utilized in the at least one corrosion inhibiting formula contained in the present invention, the weight ratio of alkali or alkaline-earth metal oxide to silicate can vary. In one embodiment, this ratio of metal oxide to silicate is from about 5:1 to about 1:5. In another embodiment, the ratio of metal oxide to silicate is from about 3:1 to about 1:3.

In another embodiment, a mixture of one or more silicates can be utilized in the at least one corrosion inhibiting formula contained in the present invention. In yet another embodiment, the one or more silicates can be in a glassy or crystalline state.

In yet another embodiment, at least one alkali or alkaline-earth metal oxide is utilized in the at least one corrosion inhibiting formula contained in the present invention rather than, or in addition to, the one or more silicates discussed above. Exemplary alkali and alkaline-earth metal oxides include, but are not limited to, magnesium oxide, calcium oxide, strontium oxide and barium oxide. In another embodiment, a mixture of two or more alkali or alkaline-earth metal oxides can be utilized in the at least one corrosion inhibiting formula of the present invention.

### d. Fumed Silica

Any suitable fumed silica can be utilized in the at least one corrosion inhibiting formula contained in the present invention. Suitable fumed silicas are available under the tradenames Cab-O-Sil from Cabot Corporation and Aerosil from American Cyanamid.

### e. Chemically Active Compound

If present, the at least one chemically active compound utilized in the at least one corrosion inhibiting formula contained in the present invention can be an oxide compound, or combination thereof, which can react with one or more compounds to form compounds which are insoluble in aqueous environments. Exemplary chemically active compounds include, but are not limited to, iron oxides (both ferrous oxide and ferric oxide), cobalt oxide, nickel oxide, copper oxides (both cuprous oxide and cupric oxide) and zinc oxide.

In another embodiment, mixtures of two or more of the above-mentioned oxides can be utilized.

### f. Additional Additives

In addition to components (1a) to (1d) (or (2a) to (2e)), the at least one corrosion inhibiting formula contained in the present invention may also contain other additives, such as UV-protectants, anti-bacterials, anti-mildews, etc.

In one embodiment, the one or more corrosion inhibiting formulas contained in the present invention are acid-free (i.e., the mixtures contain an amount, if any, of acidic compounds which does not adversely affect the final pH of the corrosion inhibiting formulas of the present invention). For example, in one embodiment, acid free can mean having a pH of more than about 5, or more than about 6, or even more than about 7.

In another embodiment, the one or more corrosion inhibiting formulas contained in the present invention optionally contain at least one odor-suppressing compound. Such compounds include, but are not limited to, iron oxides (both ferrous oxide and ferric oxide), cobalt oxide, nickel oxide, copper oxides (both cuprous oxide and cupric oxide), zinc oxide, magnesium oxide and calcium oxide.

### g. Examples

The above corrosion inhibiting formulas are further illustrated by the following examples wherein the term “parts” refers to parts by weight unless otherwise indicated. The following examples are not meant to be limiting, rather they are illustrative of only a few embodiments within the scope of the present invention.

Examples A-1 to A-3 describe the preparation of corrosion inhibiting formulas.

### Example A-1

| | |
|---|---|
| Sodium Nitrate | 2.5 Parts |
| Sodium Silicate¹ | 0.2 parts |
| “Ionol”² | 0.5 parts |
| “Cab-O-Sil”³ | 0.1 parts |

¹Sodium Silicate is a glassy product with a weight ratio of silica to sodium oxide of 2 (commercially available from the PQ Corporation).
²“Ionol” is 2,6-di-tert-butyl-4-methyl phenol (commercially available from the Uniroyal Chemical Company).
³“Cab-O-Sil” is fumed silica (commercially available from the Cabot Corporation).

### Example A-2

| | |
|---|---|
| Sodium Nitrite | 2.5 parts |
| Sodium Silicate | 0.2 parts |
| “Cobratec TT-85”⁴ | 0.5 parts |
| “Ionol” | 0.5 parts |
| “Cab-O-Sil” | 0.1 parts |

⁴“Cobratec TT-85” is sodium tolyltriazole, a corrosion inhibitor commercially available from the Sherwin-Williams Company.

### Example A-3

| | |
|---|---|
| Sodium Nitrite | 2.5 parts |
| Sodium Silicate | 0.2 parts |
| “Ionol” | 0.5 parts |
| “Cobratec TT-85” | 0.5 parts |
| Zinc Oxide | 1.0 parts |
| “Cab-O-Sil” | 0.1 parts |

2. Exemplary Tarnish Inhibiting Formulas:

As noted above, in one embodiment, the present invention relates to systems which can contain therein at least one tarnish inhibiting formula which comprises a mixture of: (4a) at least one strong alkali compound; and (4b) at least one compound which yields an insoluble sulfide. This mixture can further include one or more additional additives, such as anti-oxidants, corrosion inhibitors, etc.

a. Strong Alkali Compound:

Any suitable Group 1 or 2 silicate or oxide can be utilized in the at least one tarnish inhibiting formula contained in the present invention as component (4a), the at least one strong alkali compound. Exemplary silicates include, but are not limited to, lithium silicate, sodium silicate, potassium silicate and barium silicate. With regard to the silicates utilized in the present invention, the weight ratio of alkali or alkaline-earth metal oxide to silicate can vary. In one embodiment, this ratio of metal oxide to silicate is from about 5:1 to about 1:5. In another embodiment, the ratio of metal oxide to silicate is from about 2.5:1 to about 1:2.5.

In another embodiment, a mixture of one or more silicates can be used in the at least one tarnish inhibiting formula contained in the present invention. In yet another embodiment, the one or more silicates can be in a glassy or crystalline state.

In yet another embodiment, the at least one alkali or alkaline-earth metal oxide is utilized in the at least one tarnish inhibiting formula contained in the present invention rather than the one or more silicates. Exemplary alkaline-earth metal oxides include, but are not limited to, magnesium oxide, calcium oxide, strontium oxide and barium oxide. In another embodiment, a mixture of two or more alkali or alkaline-earth metal oxides can be utilized in the at least one tarnish inhibiting formula contained in the present invention.

While not wishing to be bound to any one theory, it is believed that the one or more strong alkali compounds react with any hydrogen sulfide (H₂S) and/or any acid compounds present in the environment. This prevents such compounds and/or acids from passing through the polymer matrix of a polymer article which optionally contains therein a tarnish inhibiting formula, according to the present invention.

b. Compounds which Yield Insoluble Compounds:

Any suitable compound which forms an insoluble compound, such as a sulfide (solubility of less than about 0.1 grams/liter of water) when H₂S is present, can be utilized in the at least one tarnish inhibiting formula contained in the present invention as component (4b), the compound which yields an insoluble sulfide. Exemplary compounds include, but are not limited to, compounds containing iron, cobalt, nickel, copper and zinc. Mixtures of two or more such compounds can also be utilized in the at least one tarnish inhibiting formula contained in the present invention. Suitable anions for the compound according to component (4b) include oxides and hydroxides.

Exemplary compounds include, but are not limited to, zinc oxide, zinc hydroxide, iron oxides (both ferrous oxide and ferric oxide), iron hydroxide (Fe(OH)₂), cobalt oxide, cobalt hydroxides (both Co(OH)₂ and Co₂O_{3.3}H₂O), nickel oxide, nickel (II) hydroxide, copper oxides (both cuprous oxide and cupric oxide) and copper hydroxide. Mixtures of two or more of the above compounds can also be utilized as component (4b).

c. Volatile Corrosion Inhibitors:

In one embodiment, the tarnish inhibiting formula contained in the present invention further includes any suitable volatile corrosion inhibitor (or vapor phase corrosion inhibitor). Some suitable volatile corrosion inhibitors are disclosed in U.S. Pat. Nos. 4,290,912; 5,320,778; and 5,855,975, which are all incorporated herein by reference in their entirety for their teachings of such inhibitors. For example, useful vapor phase or volatile corrosion inhibitors include, but are not limited to, triazoles and/or inorganic nitrites (e.g., nitrite salts).

Exemplary inorganic nitrite salts include, but are not limited to, metal nitrites, such as sodium nitrite, potassium nitrite and barium nitrite. In another embodiment, any suitable Group 1 or Group 2 nitrite (New Notation System) can be used in the one or more tarnish inhibiting formulas contained in the present invention.

In another embodiment, if present, the one or more tarnish inhibiting formulas contained in the present invention can optionally include one or more vapor phase or volatile corrosion inhibitors selected from triazoles. Exemplary triazoles include, but are not limited to, benzotriazole, tolyltriazole and/or sodium tolyltriazole.

In yet another embodiment, the optional vapor phase or volatile corrosion inhibitor utilized in the present invention can be any suitable mixture of two or more of the above-mentioned volatile corrosion inhibitors.

d. Anti-Oxidants:

If desired, any suitable anti-oxidant can be utilized in the tarnish inhibiting portion of the present invention. Exemplary anti-oxidants include, but are not limited to, tri-substituted phenols substituted in the 2, 4 and 6 positions with one or more alkyl hydroxyalkyl, aryl, alkenyl or hydroxyalkenyl groups of the general formula shown below.

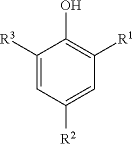

In one embodiment, the sum of the carbon atoms present in the substituent groups R¹, R² and R³ is in the range of 3 to about 36, or even in the range of 3 to about 18.

In another embodiment, a mixture of two or more of the above-mentioned anti-oxidants can be utilized in the tarnish inhibiting portion of the present invention.

e. Additional Additives:

In addition to components (4a) and (4b), the tarnish inhibiting formulas optionally contained in the present invention may also contain other additives such as, UV-protectants, anti-bacterials, anti-mildews, etc.

In one embodiment, the one or more corrosion inhibiting formulas contained in the present invention are acid-free (i.e., the mixtures contain an amount, if any, of acidic compounds which do not adversely affect the final pH of the corrosion inhibiting formulas of the present invention). For example, in one embodiment, acid free can mean having a pH of more than about 5, or more than about 6, or even more than about 7.

In another embodiment, a tarnish inhibiting formula, according to the present invention, optionally contains an odor-suppressing compound. Such compounds include, but are not limited to, iron oxides (both ferrous oxide and ferric oxide), cobalt oxide, nickel oxide, copper oxides (both cuprous oxide and cupric oxide), zinc oxide, magnesium oxide and calcium oxide.

Absorbents

An important aspect of the present invention is the utilization of one or more absorbents to collect any recycled volatilized metal corrosion inhibiting compounds whenever desired, such as at the end of a treating cycle for applying the VCI to metal to be protected, on anytime basis be it a minute, hour, daily, weekly, or any other time period. Other cycles include removal of the recycled volatile metal corrosion inhibitor compound when the metal items, substrates, parts, machines, systems, articles, and the like no longer need to be protected.

The term “sorption” encompasses “absorption” and “adsorption”. Absorption relates to a substance diffusing into a liquid or solid to generally form a solution. That is, a fluid (the absorbate) permeates or is dissolved by a liquid or solid (the absorbent). Absorption involves the whole volume of a material.

Adsorption is the accumulatibn of atoms or molecules on the surface of a material. This process creates a film of the adsorbate (the molecules or atoms being accumulated) on the adsorbent's surface. Adsorbents are used generally in the form of spherical pellets, rods, molding, or monoliths with hydrodynamic diameters between 0.5 and 10 mm, for example. They must have high abrasion resistance, high thermal stability and small pore diameters, which results in higher exposed surface area and hence high surface capacity for adsorption. The adsorbents must also have a distinct pore structure which enables fast transport of targeted molecules.

Generally two classes-types of absorbents can be used for removing/cleaning the environment from contaminants or corrosive components such as H₂S, SO₂, CO₂, Cl⁻; etc.; or for utilization with VCI. In most oases absorbents are liquid or solid chemical compositions that react/neutralize with contaminants-compound or dissolves in some liquids. Absorbents for contaminants include generally all types of alkalines, including —NaOH, KOH, Ca(OH)₂, NH₃OH. In some cases they can be a powder.

Absorbent solvents are often utilized to condense, concentrate, or extract VCI from the atmosphere. VCI absorbent examples include alumina, silica, or silica gels, e.g. amorphous SiO₂, alumino-silica gels or zeolites, and bentonite, i.e. collidial clay (aluminum silicate).

The VCIs can be in liquid form in which the VCI dissolves but does not change its chemical formula. Suitable types of liquids include compounds in which the VCI still has the required vapor pressure with respect to evaporation and can be used again, liquids that can be used in the future for extracting inhibitors, and liquids that exclude contamination.

Absorbents can be in the following forms: liquids, powders, foams, nanofibers, paper, desiccants, and combinations thereof, etc.

The above tarnish inhibiting formulas are further illustrated by the following example wherein the term “parts” refers to parts by weight unless otherwise indicated. The following example is not meant to be limiting, rather it is illustrative of only one embodiment within the scope of the present invention.

### Example B-1

The following compounds are mixed to form a tarnish inhibiting formula. This tarnish inhibiting formula is illustrated by the following example wherein the term “parts” refers to parts by weight unless otherwise indicated.

| | |
|---|---|
| Sodium Silicate | 25 parts |
| Zinc Oxide | 25 parts |

3. Other Corrosion Inhibiting Formulas and Compounds:

In yet another embodiment, the present invention relates to systems which contain therein at least one corrosion inhibiting formula which comprises a mixture of: (3a) an inorganic nitrite salt, (3b) a trisubstituted phenol and (3c) fumed silica.

The useful inorganic nitrite salts include metal nitrites (such as Group I and II metal nitrites), including potassium nitrite, sodium nitrite and calcium nitrite. In one embodiment, the nitrite salt is sodium nitrite.

The trisubstituted phenols which are useful are substituted in the 2, 4 and 6 positions with alkyl, hydroxyalkyl, aryl, alkenyl or hydroxyalkenyl. In one embodiment, the phenol is 2,6 di-t-butyl-4-methyl phenol.

Any suitable fumed silica can be utilized. An exemplary fumed silica is available commercially under the tradename “Cab-O-Sil” from the Cabot Corporation.

This corrosion inhibiting formula is further illustrated by means of the following example wherein the term “parts” refers to parts by weight unless otherwise indicated. The following example is not meant to be limiting, rather it is illustrative of only one embodiment within the scope of the present invention.

### Example C-1

| | |
|---|---|
| Sodium Nitrite | 3 parts |
| “Ionol” | 2 parts |
| “Cab-O-Sil” | 0.1 parts |
| Oleyl Alcohol | 3 parts |

### II. Heat Sources

As is noted above, the systems of the present invention contain at least one heat source. Any suitable heat source having a controllable heat output can be utilized in the present invention. Suitable heat sources include, but are not limited to, chemical heat sources (e.g., mixtures of iron powder, water, salt, activated charcoal and vermiculite) which, when exposed to air, undergo a chemical reaction and yield excess heat and battery or fuel powered non-flame heat sources (e.g., a light bulb, a heating element, etc.). One type of heat source which, in most instances, is disfavored for use in the present invention is any type of heat source which generates a flame (e.g., a Sterno can, a Bunsen burner, a cigarette lighter, etc.). This type heat source is generally disfavored for use in the present invention because it could lead to fire hazards and the temperature of the heat output is generally difficult to control.

### III. Exemplary Embodiments

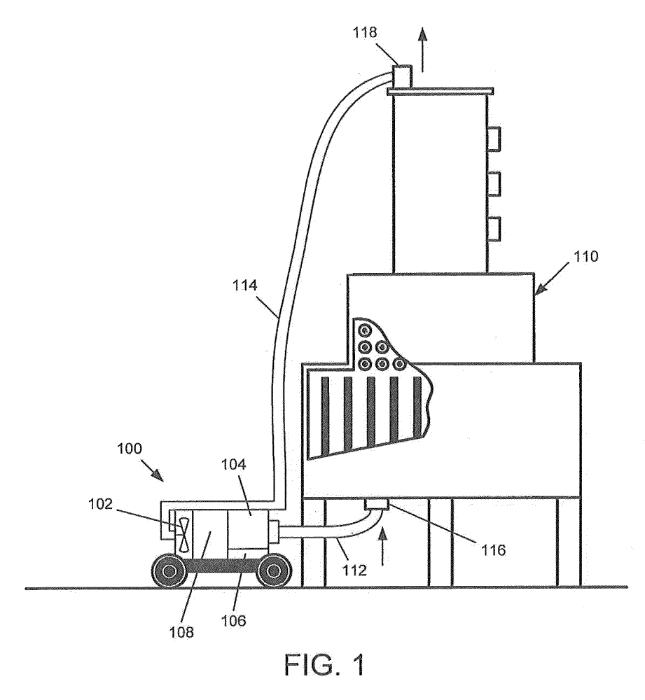

The following discussion relates to exemplary embodiments of the present invention. However, it should be noted that the present invention is not limited thereto. Additionally, although the embodiments of FIGS. 1 through 5 illustrate only one system according to the present invention, the present invention contemplates embodiments where two or more such systems are utilized. Furthermore, although some and/or all of the embodiments of the present invention are shown with one heat source, the present invention contemplates embodiment where two or more heat sources are utilized.

As is noted above, in one embodiment, the present invention relates to a system that is designed to deliver one or more corrosion inhibiting compounds to one or more fully sealed enclosures, and to methods of using same. By fully sealed enclosure it is meant that such an enclosure does not permit the infusion, intrusion and/or inclusion of any environment external to the interior of the fully sealed enclosure. In these embodiments, the present invention permits, simultaneously, a change in the environment of the enclosure and delivery of one or more corrosion inhibiting compounds to an interior environment.

In another embodiment, the present invention can be used to provide one or more corrosion inhibiting compounds to one or more partially sealed enclosures. By partially sealed enclosure it is meant that the enclosure is not totally and/or completely sealed from any one or more environments external to the interior of the partially sealed enclosed. Given this, such partially sealed enclosures permit and/or allow the infusion, intrusion and/or inclusion of an external environment into the interior of the partially sealed enclosure. In certain instances, in the case of partially sealed enclosures, the present invention can be designed to provide an over pressure to the enclosure (i.e., a pressure greater than the surround pressure of the external atmosphere) thereby preventing and/or reducing the amount of external atmosphere that enters a given enclosure.

In another embodiment, the present invention can be used to provide one or more corrosion inhibiting compounds to an open enclosure. In this instance, an open enclosure is defined as an enclosure that is not totally sealed from an external atmosphere and thus permits any amount of external atmosphere to enter the enclosure. In certain instances, in the case of open enclosures, the present invention can be designed to provide an over pressure to the enclosure (i.e., a pressure greater than the surround pressure of the external atmosphere) thereby preventing and/or reducing the amount of external atmosphere that enters a given enclosure.

In still another embodiment, the present invention can contain one or more filters or filtration devices designed to remove from an atmosphere passing there through one or more deleterious compounds. Examples of compounds that can be removed include, but are not limited to, H₂S, SO₂, CO₂, Cl⁻, and H₂O.

Turning to the Figures, FIG. 1 illustrates a system 100 in accordance with one embodiment of the present invention. In the embodiment of FIG. 1 system 100 is a portable VCI and/or desiccant unit that contains a fan 102 that creates directional air flow as noted by the arrows in FIG. 1. In should be noted that the embodiment of FIG. 1 is not limited to just fan 102. Rather any means (e.g., a vacuum) that is able to generate directional air flow can be utilized in conjunction with the embodiment of FIG. 1. System 100 further includes a corrosion inhibiting portion 104, a heat source 106 and a desiccant portion 108. As is noted above, although system 100 is shown having both a corrosion inhibiting portion 104 and a desiccant portion 108, the present invention is not limited to embodiments having both. Rather, one or the other of the corrosion inhibiting portion 104 or a desiccant portion 108 can be used in conjunction with the present invention. Additionally, although system 100 is shown with heat source 106, a heat source is not a requirement for all embodiments of the present invention. For example, a heat source 106 is not necessary where no corrosion inhibiting portion 104 is present, or in the situation where system 100 is utilized in an environment where a heat source would be redundant (e.g., a dessert environment, a tropical environment, the interior of a steel plant, etc.).

As shown in FIG. 1, system 100 is connected to a large electrical substation enclosure 110 via tubes 112 and 114. Tubes 112 and 114 are, in one embodiment, removably and/or permanently connected to inputs/outputs 116 and 118 in enclosure 110. It should be understood that although system 100 is shown in conjunction with an electrical substation enclosure, portable system 100 can be used in conjunction with any type of enclosure (e.g., a garage, a warehouse, shipping containers, storage tanks, ship holds, etc.) that is permanently or temporarily stationary where corrosion and/or tarnish mitigation is desired.

In operation, system 100 of FIG. 1 supplies corrosion inhibitor-laden air to the interior environment of enclosure 110, as is denoted by the arrows in FIG. 1, in order to mitigate and/or negate the effects of corrosion and/or tarnish causing compounds that may exist/occur in the interior environment of enclosure 110. Additionally, if present, any desiccant section/portion contained in system 100 acts to remove some and/or all of the water vapor from the atmosphere that is being circulated through enclosure 110 due the directional air flow provided by fan 102.

It should be noted, that the embodiment of FIG. 1 is not limited to just the flow pattern where the input is at the bottom of enclosure 110. Rather, any input/output arrangement can be used in conjunction with enclosure 110, so long as a suitable amount of inhibitor is delivered to the internal environment of enclosure 110. In one embodiment, system 100 can also cause a pressure increase within the interior of enclosure 110 in order to prevent and/or reduce any deleterious compounds from entering enclosure 110 from the external environment surrounding enclosure 110.

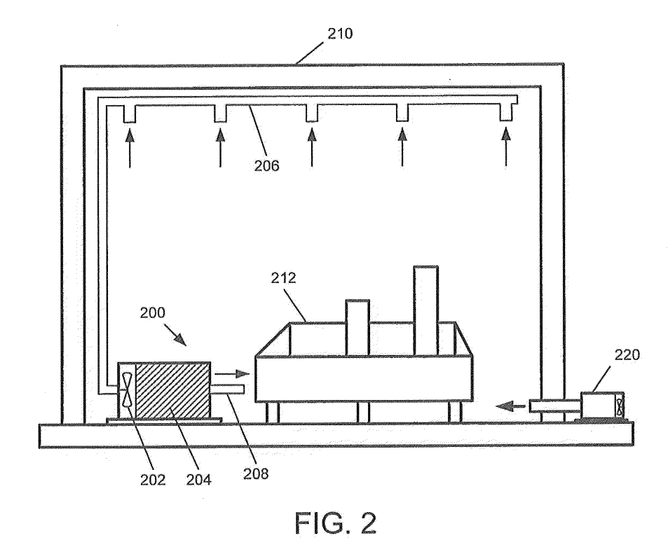

Turning to FIG. 2, system 200 is shown in conjunction with a permanent enclosure 210. In the embodiment of FIG. 2, system 200 is a fixed VCI and/or desiccant unit, although system 100 of FIG. 1 can be used in place of system 200, if so desired. In the embodiment of FIG. 2 system 200 contains a fan 202 that creates directional air flow as noted by the arrows in FIG. 2. In should be noted that the embodiment of FIG. 2 is also not limited to just fan 202. Rather any means (e.g., a vacuum) that is able to generate directional air flow can be utilized in conjunction with the embodiment of FIG. 2. System 200 further includes any suitable combination 204 of a corrosion inhibiting portion, a heat source, and a desiccant portion. Again, system 200 is not limited to just embodiments where a heat source is present. For example, a heat source is not necessary where no corrosion inhibiting portion is present, or in the situation where system is utilized in an environment where a heat source would be redundant (e.g., a desert environment, a tropical environment, the interior of a steel plant, etc.).

As shown in FIG. 2, system 200 is placed within the interior of a large enclosure (e.g., a warehouse, factory, or other building) where a large item 212 is either being built and/or stored. Exemplary items 212 that may be present within such disclosures include, but are not limited to, ships (or portions thereof), planes (or portions thereof), cars, tanks, artillery, missiles, finished metal products (e.g., metal rolls, rods, or sheets—such as steel rolls), finished appliances, or any product (or portion thereof) that needs to be stored in a reduced corrosion environment. In this embodiment, system 200 is connected to intake 206 and output 208 for supplying corrosion inhibitor-laden air to the interior environment of enclosure 210, as is denoted by the arrows in FIG. 2, in order to mitigate and/or negate the effects of corrosion and/or tarnish causing compounds that may exist/occur in the interior environment of enclosure 210. Additionally, if present, any desiccant section/portion contained in system 200 acts to remove some and/or all of the water vapor from the atmosphere that is being circulated through enclosure 210 due the directional air flow provided by fan 202.

It should be noted, that the embodiment of FIG. 2 is not limited to just the flow pattern where the input is at the top of enclosure 210. Rather, any input/output arrangement can be used in conjunction with enclosure 210, so long as a suitable amount of inhibitor is delivered to the internal environment of enclosure 210. In one instance, system 200 can also cause a pressure increase within the interior of enclosure 210 in order to prevent and/or reduce any deleterious compounds from entering enclosure 210 from the external environment surrounding enclosure 210. Alternatively, one or more additional pressure increasing means, such as pump 220, can be used to cause an increase in the internal atmospheric pressure of enclosure 210.

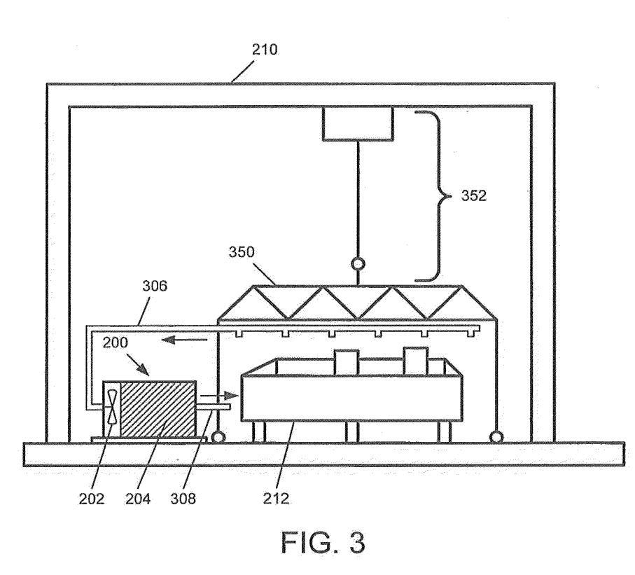

Turning to FIG. 3, system 200 is shown in conjunction with a permanent enclosure 210. In the embodiment of the FIG. 3, system 200 is a fixed VCI and/or desiccant unit, although system 100 of FIG. 1 can be used in place of system 200, if so desired. In the embodiment of FIG. 3 system 200 contains a fan 202 that creates directional air flow as noted by the arrows in FIG. 3. In should be noted that the embodiment of FIG. 3 is also not limited to just fan 202. Rather any means (e.g., a vacuum) that is able to generate directional air flow can be utilized in conjunction with the embodiment of FIG. 3. System 200 further includes any suitable combination 204 of a corrosion inhibiting portion, a heat source, and a desiccant portion. Again, system 200 is not limited to just embodiments where a heat source is present. For example, a heat source is not necessary where no corrosion inhibiting portion is present, or in the situation where system is utilized in an environment where a heat source would be redundant (e.g., a dessert environment, a tropical environment, the interior of a steel plant, etc.).

As shown in FIG. 3, system 200 is placed within the interior of a large enclosure (e.g., a warehouse, factory, or other building) where a large item 212 is either being built and/or stored. Exemplary items 212 that may be present within such disclosures include, but are not limited to, ships (or portions thereof), planes (or portions thereof, cars, tanks, artillery, missiles, finished metal products (e.g., metal rolls, rods, or sheets—such as steel rolls), finished appliances, or any product (or portion thereof) that needs to be stored in a reduced corrosion environment.

In this embodiment, system 200 is removably connected to intake 306 and output 308 for supplying corrosion inhibitor-laden air to the interior environment of a movable and/or collapsible sub-enclosure 350 that is located within enclosure 210 and isolates a portion of the interior environment of enclosure 210 that immediately surrounds item 212. Additionally, if present, any desiccant section/portion contained in system 200 acts to remove some and/or all of the water vapor from the atmosphere that is being circulated through enclosure 350 due the directional air flow provided by fan 202.

As can be seen from FIG. 3, sub-enclosure 350 can be lifted and/or moved via any suitable means. For example, a crane lift system 352 can be used to move and/or lift sub-enclosure 350. Again, it should be noted, that the embodiment of FIG. 3 is not limited to just the flow pattern where the input is at the top of sub-enclosure 350. Rather, any input/output arrangement can be used in conjunction with sub-enclosure 350, so long as a suitable amount of inhibitor is delivered to the internal environment of sub-enclosure 350. In one instance, system 200 can also cause a pressure increase within the interior of sub-enclosure 350 in order to prevent and/or reduce any deleterious compounds from entering sub-enclosure 350 from the external environment surrounding sub-enclosure 350. Alternatively, one or more additional pressure increasing means, such as one or more pumps (e.g., see the embodiment of FIG. 2), can be used to cause an increase in the internal atmospheric pressure of sub-enclosure 350.

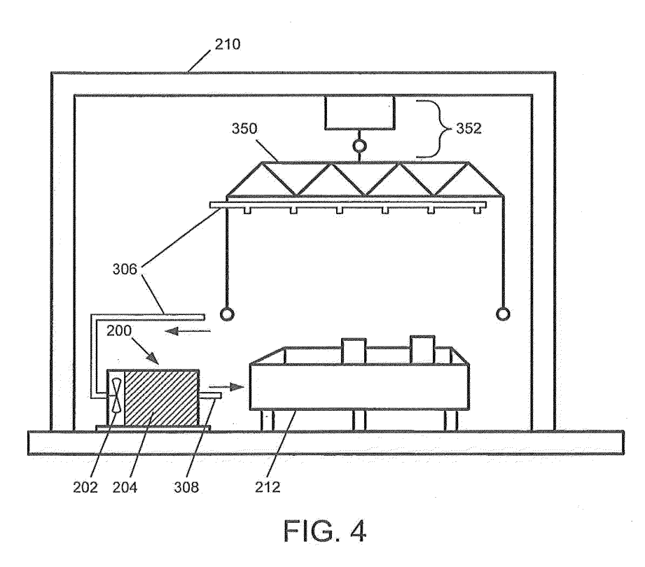

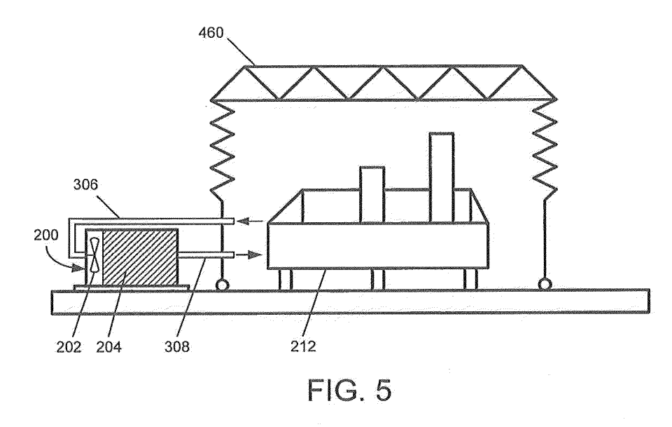

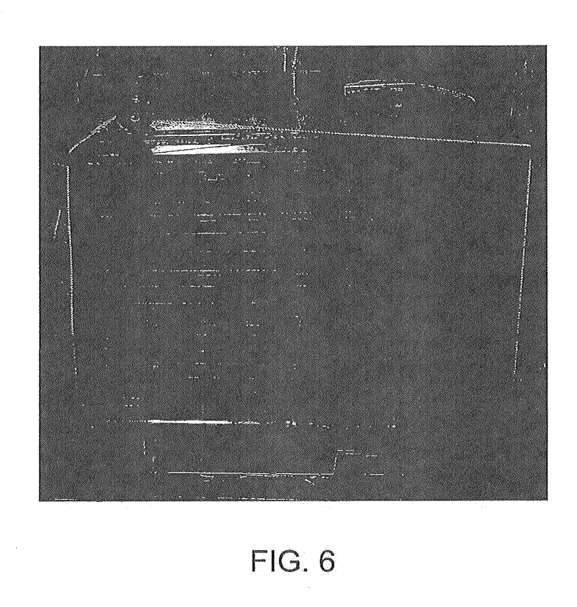

Turning to FIGS. 4 and 5, FIG. 4 illustrates the instance where sub-enclosure 350 has been lifted, while FIG. 5 illustrates an embodiment where the main enclosure 210 has been done away with and all that remains is a moveable and/or collapsible enclosure 460. FIG. 6 is a picture of a model of the embodiment of FIG. 5.

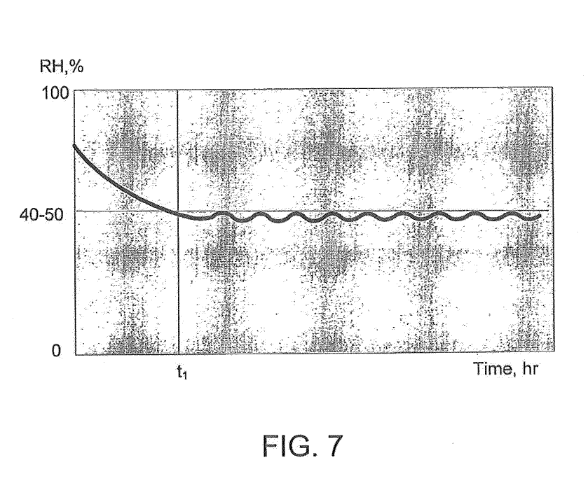

Turning to FIGS. 7 through 9, FIG. 7 is a graph illustrating an exemplary drop in relative humidity provided by a system in accordance with one embodiment of the present invention, where such system contains a desiccant section. Ideally, the Relative Humidity (RH) in a given enclosure needs to be reduced and maintained at or below 50% RH, or even at or below 40% RH. In the case of the present invention, it is possible to achieve the necessary reduction in relative humidity prior to the start of corrosion (denoted as time t₁ in FIG. 7).

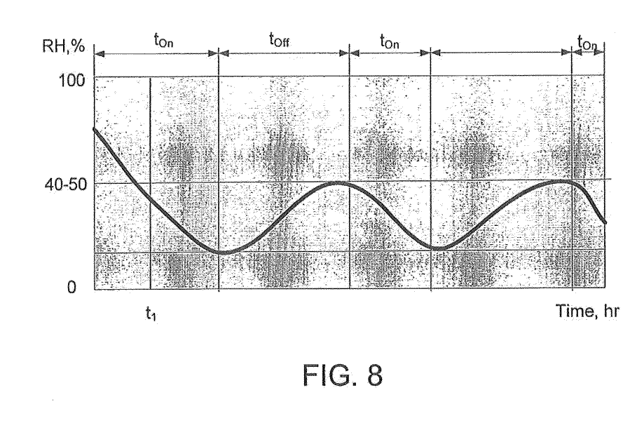

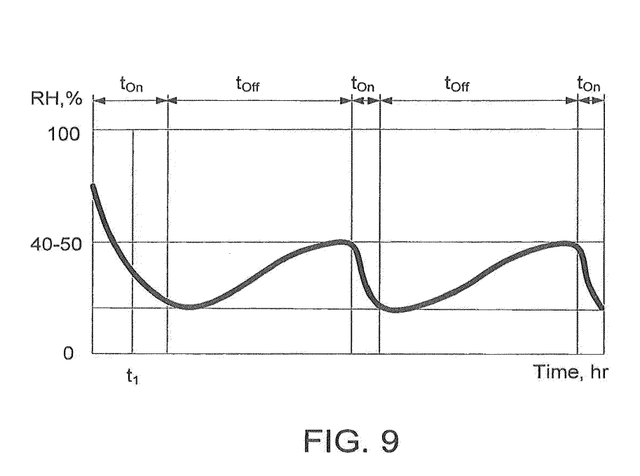

In another embodiment, a system in accordance with the present invention can be cycled on and off in response to an increase in the relative humidity in an enclosure, or based on a time table cycle-schedule. FIGS. 8 and 9 illustrate humidity plots for systems in accordance with the present invention, where such systems are designed to cycle on and off. As can be seen from FIGS. 8 and 9, a variety of relative humidity plots are possible with the present invention. Whereas FIG. 8 has a relatively smooth transition between the high and low relative humidity values, FIG. 9 is designed to be on for shorter periods of time but to deliver a quicker reduction in the relative humidity.

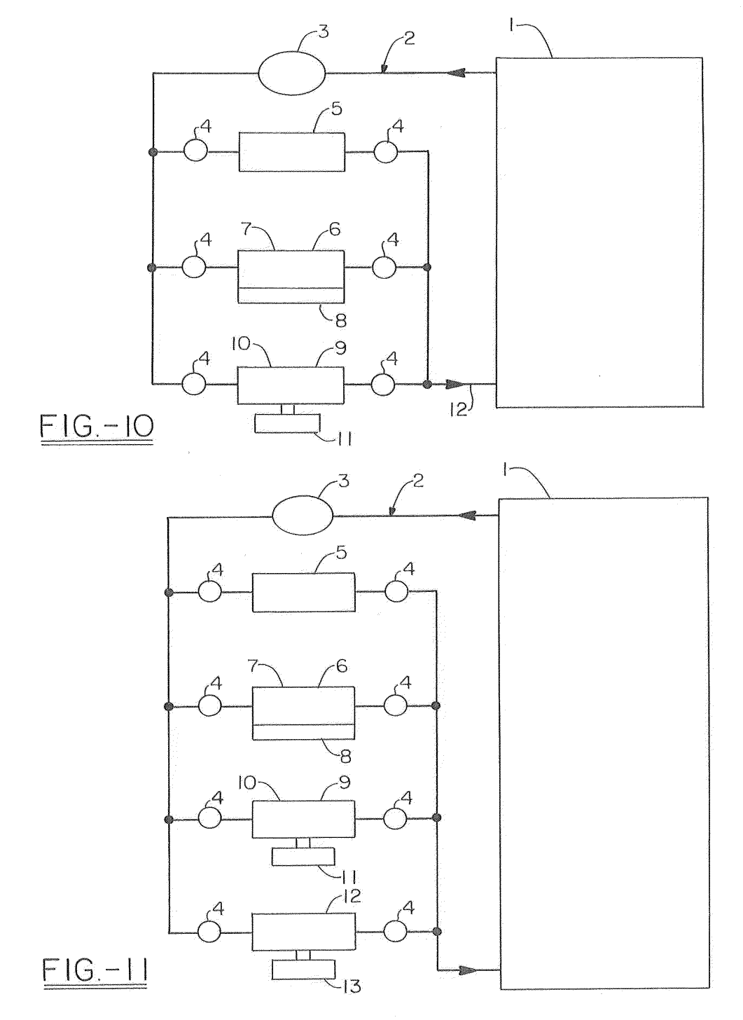

The schematic embodiment of FIG. 10 relates to a system wherein the various components of the present invention such as a dehumidifier 5, a volatilizable corrosion inhibitor 6, and the like can be located in a single housing or container, or separated. Enclosure 1 of FIG. 10 is connected by a mechanical device for delivering the atmosphere of the enclosure to a directional air flow device such as fan 3. As previous noted, the directional air flow device can be generally any device that moves air and the like and thus can be a pump such as a fan, an impeller pump, a vacuum pump, a pressurizing device, and the like. The mechanical deliver device 2 can be a pipe, a hose, conduit tube, and the like and the same is utilized for connection with all the various other components set forth in FIG. 10. The recycled air from enclosure 1 can be subjected to one or more and in any order of the various system components such as dehumidifier 5, and a volatilizable corrosion inhibitor container 7 that contains one or more volatile corrosion inhibitors 6 and heater 8. Additional components include an absorbent container 10 that contains one or more absorbents 9, as discussed above, therein. Collection reservoir 11 contains collected volatile corrosion inhibitor therein. The description of such components when set forth above are fully incorporated by reference. The system of FIG. 10 also contains various valves 4 between each component that regulate the flow of the atmosphere to each component such as the dehumidifier, VCI generator, absorbent, etc., between each component so that the recycled atmosphere can be subjected to one or more operations, either step wise or two or more steps conducted simultaneously. Generally, it is preferred that only one operation occur for any given time interval.

The one or more metal items that are contained within Enclosure 1 can generally be any metal items that need to be protected such as tools, machine parts, automotive components, and the like that need to be protected during storage and so forth. The metals that are protected generally include any type of metal that is subject to corrosion, rust, oxidation, as by the earth's atmosphere, or more desirable from corrosive gases such as various acids, oxidizing agents, and compounds as noted above such as H₂S and SO₂. Alternatively, the items within Enclosure 1 can be larger items such as machines, computer systems, instruments, various devices, vehicles, and the like including compounds noted hereinabove such as the following or parts or components thereof, for example ships, planes, tanks, artillery, missiles, appliances, and the like.

The various components of FIG. 10 can generally be utilized in any order. For example, the VCI-heater unit can only be utilized with valves 4 leading to the other components, for example dehumidifier 5 and absorbent 8 being closed. The atmosphere to Enclosure 1 is recycled until it is deemed that enough VCI has been applied to metal compounds inside Enclosure 1 and to the atmosphere to protect the metals from corrosion and to rid the atmosphere of various corrosive gases as indicated above. Since most environments contain a fair amount of humidity, a desired method of operation is to utilize only dehumidifier component 5 until the humidity in Enclosure 1 is reduced to a predetermined amount. Subsequently, a valve leading to dehumidifier component is closed and a valve leading to VCI-heater components 7 and 8 is opened to achieve the above-noted aspect of eradicating any hazardous gases and coating the one or more metal machine systems within Enclosure 1 to prevent them from being corroded. A preferred method of operation involves the steps of dehumidifying the enclosure, subsequently applying the VCI compounds thereto, terminating recycling of the VCI compound by closing valve 4 to VCI unit 7 and opening valve 4 that leads to absorbent chamber 10 and then recycling the atmosphere to only absorbent container 10 whereby any remaining or unused VCI is absorbed and can be collected in reservoir 11. The required treatment of time of items within Enclosure 1 can be one or more days, one or more weeks, one or more months, and even one or more years. The type of VCI absorbent can be any of the compounds noted hereinabove. This method is environmentally friendly and also cost efficient with respect to later recycling the collected, absorbed VCI compounds in another corrosion protection operation or cycle.

It is an aspect of the present invention that the various volatile corrosion inhibitors 6 can condense out on the metals of enclosure 1 and thus form a film or cover that protects the same. The operation with respect to dehumidification and treatment with volatilized metal corrosion inhibitors can be intermittent or continuous. As noted, once it is deemed that sufficient treatment of the various metal components of enclosure 1 has occurred, the recycled atmosphere can be directed to absorbent 9 wherein the remaining or unused volatilized metal corrosion inhibitor is absorbed, i.e. generally liquified, and can subsequently be stored in collection reservoir 11.

The system of FIG. 10 can be applied to an enclosure generally of any volume, for example larger than 2, or 5, or 10 cubic meters: up to about several thousand cubic meters. It is very aggressive system in treating the environment and protecting metal components thereof. Furthermore, generally any type of metal corrosion inhibitor can be utilized such as those set forth hereinabove.

The embodiments of FIG. 11 are similar to that of FIG. 10 wherein like numbers represent like components or parts. Moreover, the various types of operations of FIG. 11 can be similar if not identical to that described in FIG. 10 and hence will not be repeated for sake of brevity. Accordingly, the description, the various aspects, and operations of the embodiments or systems of FIG. 10 are hereby fully incorporated by reference. A different aspect of FIG. 11 is the utilization of one or more similar or different types of filter 12 that can be utilized with respect to the type of contaminate. For example, should Enclosure 1 contain a dusty environment, it is desirable to remove the dust, particles, and the like as by recycling the atmosphere of Enclosure 1 through filter 12 that can be located in a container with the dust collected being stored in collector 13.

The operation of the embodiment of FIG. 11 that utilizes filter 12 can be carried out in any manner and can be any step of the VCI treatment process. That is the use of filter 12 can occur initially, at any subsequent stage, or last, or at multiple different times during the VCI treatment process. Desirably, the filtration step is initially utilized before any of the other process steps such as dehumidification, addition of VCI vapor, and the like. Thus, while valves 4 are closed to all of the other components, the atmosphere of Enclosure 1 through line 2 and fan 3 is fed into filter container 12 with valves 4 thereof being open. After sufficient amount of time wherein the contaminate of the enclosure is reduced to a desirable level, valve 4 leading to filter container 12 can be closed. Subsequently, any of the other process steps or components can be utilized such as admitting VCI through corrosion inhibitor container 7 to the enclosure. Alternatively, the dehumidifier can initially be utilized followed by the utilization of VCI component 7. As with embodiment of FIG. 10, VCI treatment can continue until the metals therein are sufficiently treated with the corrosion inhibitor to protect the same against oxidation, corrosion, etc. After a desired amount of time that can be hours, days, weeks, etc., the addition of VCI can be stopped. After a desirable time such as once the metals are protected with the VCI compound, the atmosphere within Enclosure 1 can be recycled to absorption container 10 where the VCI compound is removed in a manner described hereinabove with regard to FIG. 10 and collected in reservoir 11. Later, the collected VCI can be use, i.e. recycled, in another corrosion protection operation or process. The operation of the embodiment of FIG. 11 can be either sequential, or simultaneous, or a combination of both.

The filter of filter container 12 can utilize typical filter compounds, for example porous paper and the like, plastics such as polyester and other synthetic or natural fibers, and the like, as known to the art and to the literature. Alternatively, the filter can contain absorbents as set forth hereinabove or adsorbents. Examples of adsorbents include activated carbon as for adsorbing organic substances and non-polar adsorbates such as waste gas treatments, and the like. Protein adsorption can also be utilized where it is desirable to rid the enclosure of biomaterials. Another type of filter are those that can capture and destroy various virus should the enclosure so be contaminated. The various contaminates separated out by the filter can be collected in filter collection container 13. Such adsorption compounds are known to the literature as well as to the art.

In summary, the operations of the various components of FIGS. 10 and 11 are carried out individually and sequentially or two or more operations can be carried out simultaneously. For example, dehumidification of the enclosure and simultaneous treatment with the VCI compound can be conducted.

The structures or assemblies of FIGS. 10 and 11 can be permanent, that is for example stationary located adjacent to Enclosure 1, or located therein. Alternatively, they can be portable, i.e. located in either inside or outside an enclosure and are movable, for example located on wheels, and thus can be transferred from one enclosure to another.

Although not wishing to be bound to any set of advantages, or any one advantage, the present invention is believed to deliver the following advantages over currently available systems.

(1) The present invention provides for increased and/or portable dehumidification, which is the first step in preventing, delaying and/or reducing corrosion;

(2) The present invention permits one to select various dehumidification rates and/or speeds depending upon the environment conditions present within the one or more enclosures to be protected;

(3) The present invention permits the relative humidity of one or more enclosures to be reduced to less than about 50%, less than about 40%, less than about 30%, or even less than about 20% for extended periods of time in order to prevent, delay and/or reduce corrosion. In one embodiment, the present invention can further include a humidity sensing unit that automates the on and off cycles of the systems of the present invention;

(4) The present invention also permits high speed of dehumidification due to the creation of circulation within an enclosure;

(5) The present invention also permits high speed delivery of one or more corrosion inhibiting compounds/formulas;

(5) The present invention can also provide corrosion protection in enclosed environments where the relative humidity therein is more than about 50%, more than about 60%, more than about 70%, or more than about 80%, or more than about 90%, or even up to about 100% due to the ability of the systems of the present invention to deliver an increased amount/partial pressure of one or more corrosion inhibiting compounds/formulas; and

(6) The present invention permits the use of lower concentrations of one or more corrosion inhibiting compounds/formulas due while delivering a increased level of protection due to the use of constant and/or automated low vapor pressure delivery of such compounds.

Although the invention has been shown and described with respect to certain embodiments, it is obvious that equivalent alterations and modifications will occur to others skilled in the art upon the reading and understanding of this specification. In particular with regard to the various functions performed by the above described components, the terms (including any reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A process for protecting metals in an enclosure, comprising the steps of:
volatilizing at least one metal corrosion inhibitor compound;
delivering said volatilized metal corrosion inhibitor compound to said enclosure;
recycling the interior atmosphere of said enclosure containing said volatilized metal corrosion inhibitor; and
sorbing said volatile corrosion metal inhibitor from said recycled atmosphere.

2. The process of claim 1, including dehumidifying the interior atmosphere of said enclosure.

3. The process of claim 2, including simultaneously dehumidifying said atmosphere of said enclosure and volatilizing said metal corrosion inhibitor compound.

4. The process of claim 2, including conducting said volatilizing step subsequent to said dehumidifying step.

5. The process of claim 4, wherein said sorbent is an absorbent.

6. The process of claim 1, wherein said sorbent comprises alumina, silica, silica gel, alumino-silica gel, zeolite, bentonite clay, NaOH, KOH, Ca(OH)₂, NA₃OH, activated carbon, and any combination thereof.

7. The process of claim 1, wherein said VCI is a Group 1 or Group 2 nitrite; a triazole; anhydrous sodium molybdate [Na2MoO4]; anhydrous ammonium dimolybdate [(NH4)2MoO4]; or an anhydrous amine-molybdate having the general structural formula 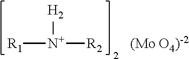
wherein R₁ is an aliphatic hydrocarbon having up to 7 carbon atoms, and wherein R₂ is either hydrogen or an aliphatic hydrocarbon having up to 7 carbon atoms, or wherein R₁ is 2-ethylhexyl, cyclohexyl, or dicyclohexyl; or cyclohexylamine benzoate; ethylamine benzoate; or dicyclohexylamine nitrate; or any combination thereof.

8. The process of claim 5, wherein said absorbent comprises alumina, silica, silica gel, alumino-silica gel, zeolite, or bentonite, or any combination thereof; and said VCI compounds comprise sodium nitrite, potassium nitrite, benzotriazole, tolyltriazole, or sodium tolyltriazole, or any combination thereof.

9. The process of claim 8, including subsequently recycled said absorbed VCI compound.

10. A system for delivering at least one volatilizable inhibiting compound to at least one enclosure, comprising:
at least one volatilizable metal corrosion inhibiting component comprising a volatile, metal corrosion inhibitor;
a heat source for volatilizing said metal corrosion inhibitor compound;
a mechanical device for delivering the at least one volatilizable, metal corrosion-inhibiting compound to the at least one enclosure;
optionally, a dehumidifying device for reducing the amount of relative humidity in the at least one enclosure;
a directional air flow device for directing the vapor phase of the at least one volatilizable, metal corrosion-inhibiting compound within the at least one enclosure and for recycling the atmosphere of the interior of the enclosure;
wherein the combination of the vapor phase of the at least one volatilizable, metal corrosion-inhibiting compound, and the directional air flow device, cause a reduction in the amount of said one or more metal corrosion causing compounds within the interior environment of the one or more enclosures; and
an absorbent for absorbing said volatilized metal corrosion inhibitor compound from the recycled atmosphere.

11. The system of claim 10, wherein said sorbent comprises alumina, silica, silica gel, alumino-silica gel, zeolite, bentonite clay, NaOH, KOH, Ca(OH)₂, NA₃OH, activated carbon, and any combination thereof.

12. The system of claim 11, wherein said volatile, metal corrosion inhibitor comprises a Group 1 or Group 2 nitrite; triazole; anhydrous sodium molybdate [Na₂MoO₄]; anhydrous ammonium dimolybdate [(NH₄)₂MoO₄]; or an anhydrous amine-molybdate having the general structural formula: 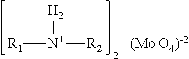
wherein R₁ is an aliphatic hydrocarbon having up to 7 carbon atoms, and wherein R₂ is either hydrogen or an aliphatic hydrocarbon having up to 7 carbon atoms, or wherein R₁ is 2-ethylhexyl, cyclohexyl, or dicyclohexyl; or cyclohexylamine benzoate; ethylamine benzoate; or dicyclohexylamine nitrate; or any combination thereof.

13. The system of claim 12, wherein said volatile, metal corrosion inhibitor comprises sodium nitrite, potassium nitrite, benzotriazole, tolyltriazole, or sodium tolyltriazole, or any combination thereof.

14. The system of claim 13, wherein said absorbent comprises alumina, silica, or silica gels, e.g. amorphous SiO₂, alumino-silica gels or zeolites, and various basic metal oxide compounds, and wherein the at least one heat source is a chemical heat source, or an electrical heat source.

15. The system of claim 10, wherein said inhibitor component is portable.

16. The system of claim 10, wherein the at least one volatilizable, metal corrosion-inhibiting compound contains at least one of the following formulas:
(1) a formula which comprises:
(1a) the at least one volatile, metal corrosion inhibitor; and
(1b) at least one anti-oxidant; or
(2) a formula which comprises:
(2a) the at least one volatile, metal corrosion inhibitor;
(2b) at least one anti-oxidant;
(2c) at least one alkali or alkaline-earth metal silicate or oxide;
(2d) fumed silica; and
(2e) at least one chemically active compound, or
(3) a formula which comprises:
(3a) an inorganic nitrite salt;
(3b) a phenol represented by the formula: 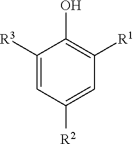
where R¹, R² and R³ are each independently selected from alkyl, aryl, alkenyl, hydroxyalkyl and hydroxyalkenyl, and where the sum of carbon atoms in R¹, R² and R³ is in the range of 3 to about 18; and
(3c) fumed silica.

17. A system for delivering at least one volatilizable inhibiting compound to at least one enclosure, comprising:
an inhibitor unit comprising:
at least one volatilizable, metal corrosion-inhibiting compound comprising a volatile, metal corrosion inhibitor;
a mechanical device for delivering an increased partial pressure and/or vapor pressure of the at least one volatilizable, metal corrosion-inhibiting compound to the at least one enclosure;
at least one heat source;
an automatic control device adapted to control the release of the at least one volatilizable corrosion-inhibiting compound;
a directional air flow device for directing the vapor phase of the at least one volatilizable, metal corrosion-inhibiting compound within the at least one enclosure; and
wherein the combination of the vapor phase of the at least one volatilizable, metal inhibiting compound and the directional air flow device cause a reduction in the amount of said one or more metal corrosion causing compounds within the interior environment of the one or more enclosures.

18. The system of claim 17, wherein the at least one enclosure contains one or more items therein, wherein said volatile, metal corrosion inhibitor is a Group 1 or Group 2 nitrite; a triazole; anhydrous sodium molybdate. [Na₂MoO₄]; anhydrous ammonium dimolybdate [(NH₄)₂MoO₄]; or an anhydrous amine-molybdate having the general structural formula: 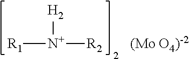
wherein R₁ is an aliphatic hydrocarbon having up to 7 carbon atoms, and wherein R₂ is either hydrogen or an aliphatic hydrocarbon having up to 7 carbon atoms, or wherein R₁ is 2-ethylhexyl, cyclohexyl, or dicyclohexyl; or cyclohexylamine benzoate; ethylamine benzoate; or dicyclohexylamine nitrate; or any combination thereof.

19. The system of claim 18, wherein said volatile, metal corrosion-inhibitor is sodium nitrite, potassium nitrite, benzotriazole, tolyltriazole, or sodium tolyltriazole, or any combination thereof.
